(19) United States
(12) Patent Application Publication
(10) Pub. No.: US 2009/0120267 A1
(43) Pub. Date: May 14, 2009

(54) METHOD OF CONSTRUCTING A LIGHT DISPLAY FOR A MUSICAL INSTRUMENT

(76) Inventor: Lloyd R. Baggs, Nipomo, CA (US)

Correspondence Address: KAUTH , POMEROY , PECK & BAILEY ,LLP, 2875 MICHELLE DRIVE, SUITE 110, IRVINE, CA, 92606, US

(21) Appl. No.: 12/251,975

(22) Filed: Oct. 15, 2008

Related U.S. Application Data
(60) Provisional application No. 60/980,896, filed on Oct. 18, 2007.

(51) Int. Cl. G09B 15/00; A63J 17/00

(52) U.S. Cl. 84/464 R; 84/477 R

(57) ABSTRACT

A light display that is mountable on a musical instrument is provided such that musical indicators are visible through the light display housing when illuminated by a light source but otherwise remains opaque or not visible.

### CROSS-REFERENCE TO RELATED APPLICATIONS

This application claims the benefit of U.S. Provisional Application No. 60/980,896, filed Oct. 18, 2007, the entire disclosure of which is hereby incorporated by reference as if set forth in full herein.

### FIELD OF THE INVENTION

The present invention relates to devices mounted to musical instruments that include light emitting optical displays and more specifically to guitar preamplifiers that include light emitting optical displays.

### BACKGROUND

Amplification of a musical instrument typically involves the use of electronics that detect the sound generated by the instrument and that produce an electrical signal indicative of the detected sound. The electrical signal can then be amplified and used to create a recording of the instrument and/or provided to a speaker system. The electronics used to generate the electrical signal depend upon the nature of the musical instrument.

When an acoustic guitar is amplified, a pickup is typically used to generate an electric signal in response to vibrations of the guitar. The output of the pickup is then provided to a preamplifier that can also be incorporated into the acoustic guitar. In many instances, the preamplifier includes a control panel with an external surface outside the musical instrument. In addition to being external to the musical instrument, the control panel is often visible when a musician is playing the acoustic guitar.

An example of a preamplifier that can be used in the construction of an amplified acoustic guitar (or electric/acoustic guitar) is shown in FIG. 1. The preamplifier 10 includes a housing 12 having a control panel 14 and mounting holes 16 that can be used to fix the preamplifier to the body of an acoustic guitar. The control panel includes a number of controls that can be used to adjust volume, equalization and/or other characteristics of the electrical signal received form a pickup. The preamplifier also includes a light display 22, which is illuminated to provide information. The light display of the preamplifier shown in FIG. 1 is a tuner display that provides information to a musician concerning the pitch of a sound generated by the instrument. In the illustrated embodiment, the display includes the letters A-G, the ‘#’ symbol and indicators that can provide the musician with feedback concerning whether the string is in tune, sharp or flat relative to an indicated note. The light used to illuminate the light display 22 is generated by LEDs that are controlled by circuitry within the preamplifier. Light from the LEDs is conveyed by light pipes, which extend through the control panel 14 of the housing 12, to characters and/or symbols stenciled on a decal 24 on the control panel of the preamplifier. When light from the light pipes illuminates the characters and/or symbols stenciled on the decal, the illuminated characters and/or symbols convey information.

The decal used in the construction of the light display 22 of the preamplifier shown in FIG. 1 covers almost the entire control panel and is printed with information. In order to cover the control panel, sections of the decal are removed to accommodate the various controls 20 of the preamplifier. During assembly of the preamplifier, the decal must be aligned to ensure that the sections that have been removed from the decal are in the appropriate locations relative to the locations of the controls.

Typically, the nature of the decal is such that the decal can only be curved around a single axis. Therefore, the decal can impose limitations on the surface of the control panel. In addition, the transparency of the decal is such that the stenciled characters and/or letters that form the light display are visible even when the light display is not illuminated.

### SUMMARY OF THE INVENTION

Light displays for devices mounted to musical instruments and methods of constructing light displays are disclosed. In many embodiments, the light displays incorporate a small decal mounted to the rear surface of the device housing. In several embodiments, the decal is located within a recess of the rear surface of the control panel and a light pipe assembly presses the decal against the rear surface of the control panel to hold the decal in place. In a number of embodiments, the control panel is constructed from a material that is sufficiently transparent that the light display is visible when the decal is illuminated and is substantially invisible for all practical purposes when the decal is not illuminated.

In one aspect of the invention, preamplifiers can be constructed that do not include a decal on the exterior surface of the control panel. In another aspect of the invention, multiple surface treatments can be performed on the control panel. In a further aspect of the invention, pad printing can be used on the exterior surface of the control panel.

In one embodiment, a device for mounting to a musical instrument comprises a housing including a light display, where the light display comprises a decal located against an interior surface of the housing, a light pipe assembly configured to direct light from at least one light source through the decal and a circuit configured to selectively activate the at least one tight source. The housing is constructed from a material that is sufficiently transparent that the decal is not visible unless illuminated by the at least one light source.

In another embodiment, a musical display indicator device comprises a housing mounted on a musical instrument and including a light display, wherein the light display comprises a light pipe assembly configured to direct light from at least one light source and a circuit configured to selectively activate the at least one light source. The housing is constructed from a material that is sufficiently transparent that indicators are not visible unless illuminated by the at least one light source.

In yet another embodiment, a method of constructing a device including a light display, comprises constructing a housing that incorporates a control panel including multiple surface treatments, where an interior surface of the control panel includes a recess and connectors; positioning a decal within the recess in the interior surface of the control panel; mounting a light pipe assembly to the connectors on the interior surface of the control panel; and installing a circuit including at least one light source within the housing.

Many of the attendant features of the present invention will be more readily appreciated as the same becomes better understood by reference to the foregoing and following description and considered in connection with the accompanying drawings in which like reference symbols designate like parts throughout.

### BRIEF DESCRIPTION OF THE DRAWINGS

FIG. 1 is a photograph of a prior art preamplifier incorporating a tuner.

FIG. 2 is an isotropic cut away view of the housing of a preamplifier that includes a tuner, a stencil and an array of light pipes in accordance with an embodiment of the invention.

FIG. 3 is a side view taken along the centerline of the preamplifier shown in FIG. 2.

FIG. 4 is a semi-schematic circuit diagram of a tuning circuit that is connected to LEDs that can be activated to illuminate a light display in accordance with an embodiment of the invention.

FIG. 5 is a flow diagram of a manufacturing process that can be used to assemble a device configured for mounting to a musical instrument that includes a light display in accordance with an embodiment of the invention.

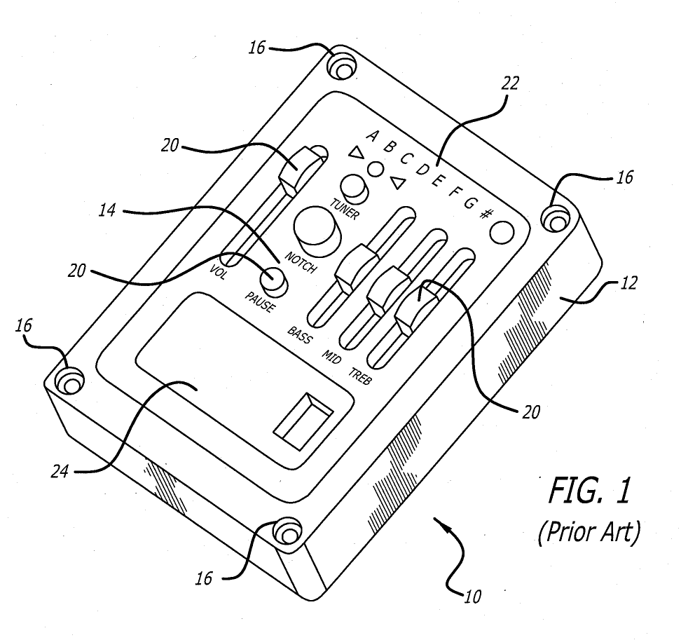

### DETAILED DESCRIPTION OF THE INVENTION

Turning now to the drawings, light displays for devices mounted to musical instruments and methods of constructing devices including light displays in accordance with embodiments of the invention are shown. In a number of embodiments, the device includes a housing having a transparent panel. A decal including stenciled characters and/or symbols is positioned against the interior surface of the transparent panel and selectively illuminating one or more of the stenciled characters and/or symbols creates a light display. In several embodiments, a light pipe assembly is used to direct light from light sources onto the stenciled characters and/or symbols. Other techniques can also be used to project light onto the stenciled characters and/or symbols. In several embodiments, the transparent panel is sufficiently transparent that the stenciled characters and/or symbols are visible when illuminated and not visible or for all practical purposes substantially invisible when not illuminated. Although much of the following refers to the incorporation of light displays into preamplifiers that are used in the construction of electric/acoustic guitars the light displays and manufacturing methods described are equally applicable in the construction of other devices mounted to musical instruments.

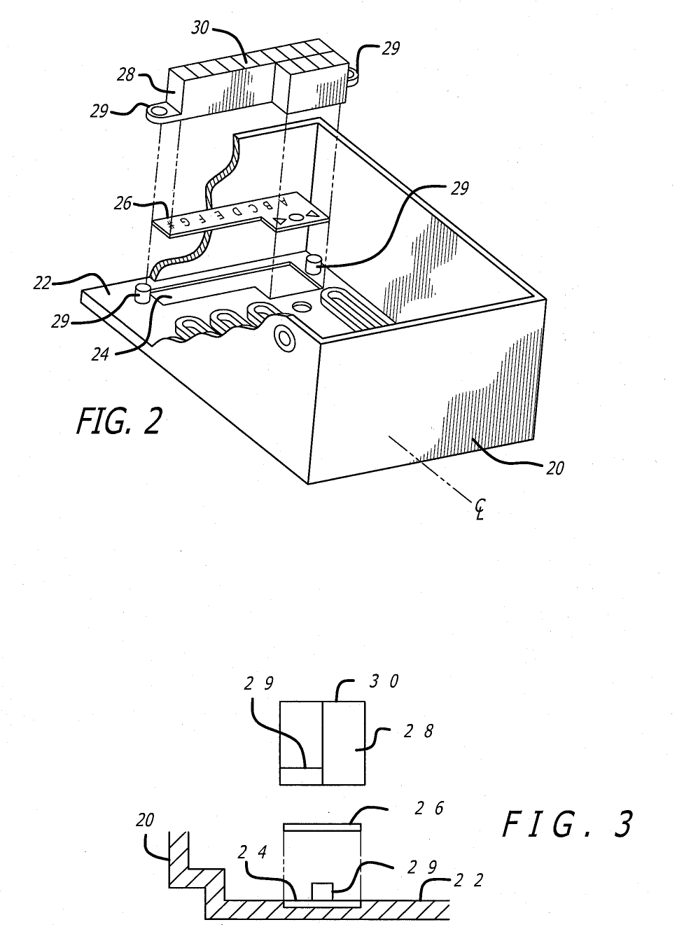

A housing for a preamplifier that includes a tuner with a light display in accordance with an embodiment of the invention is shown in FIG. 2. The preamplifier housing 20 includes a control panel 22 in which a recess 24 is located. A decal 26 on which letters and symbols are stenciled is positioned within the recess 24 and is held in place by a light pipe assembly 28 that presses against the rear surface of the stencils. The light pipe assembly is held in place by one or more connectors 29. In the illustrated embodiment, the housing includes a pair of stakes and the light pipe assembly includes a corresponding pair of flanges with openings to accommodate the stakes. Once the flanges have been inserted over the stakes, heat can be applied to the stakes to melt the stakes securing the decal in place.

When a light source illuminates the entrance 30 of a light pipe, light is directed through one of the characters and/or symbols stenciled on the decal 26. In the illustrated embodiment, the characters A-G, the “#” symbol and three symbols that can be used to indicate whether a note being played by an instrument is sharp, flat or in tune are stenciled on the decal 26. In many embodiments, the control panel 22 is sufficiently transparent that a character or symbol stenciled on the decal 26 is not visible from the outside of the housing 20 unless the character or symbol is illuminated.

In one embodiment, the color of the decal corresponds to the color of the control panel or the associated portion of the housing to assist in making the stencil visible through the display surface only when the decal is illuminated.

In one embodiment, the control panel 20 is constructed from a transparent black ABS material that includes 10% black pigment. In many embodiments, the level of pigment is between 5% and 50%. In other embodiments, the housing can be constructed from any material that has the required level of transparency. The amount of pigment in the material typically depends upon the color of the pigment, the thickness of the material and other factors including the power of the light source used to illuminate the light display.

A side view of the tuner housing, decal and light pipe assembly shown in FIG. 2 is illustrated in FIG. 3. The decal 26 can be lowered into the recess 24 in the control panel 22 and held in place by the light pipe assembly, which is connected to the housing via a stake and flange connector 29. Although the illustrated embodiment shows a recess to facilitate alignment of the decal, the stencil can simply be positioned against the display surface of the housing. Where a recess is not used, a material with higher transparency may be required to ensure illuminated characters and/or symbols are visible through the increased thickness of material.

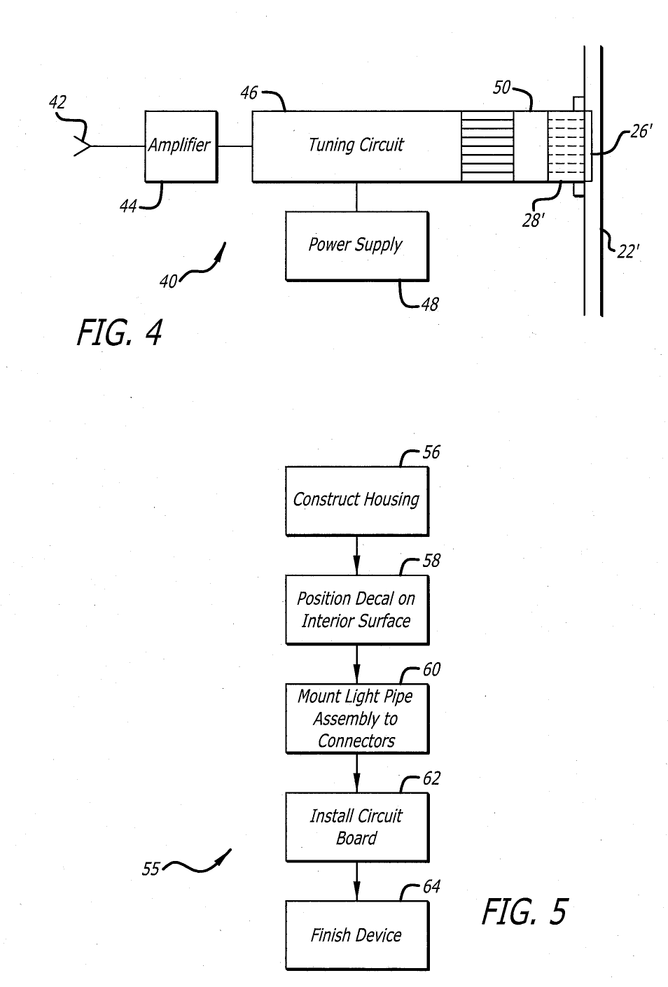

A tuner that can be incorporated into a preamplifier in accordance with an embodiment of the invention is shown in FIG. 4. The tuner 40 includes an input jack 42 that is connected to an amplifier circuit 44. The amplifier circuit 44 is connected to the tuning circuit 46. The tuning circuit 46 receives power from a power supply 48 and provides a number of outputs to an LED array 50.

The input jack 42 is configured to connect to a cable that carries an electrical signal from a pickup and provides the electrical signal as an input to the amplifier 44. The amplifier 44 amplifies received signals and conditions the signal prior to input to the tuning circuit 46. The tuning circuit 46 determines the note to which the received signal is closest and the pitch of the signal relative to the note. The tuning circuit 46 uses the determination of the note and the pitch of the signal relative to the note to select LEDs to illuminate. Illumination of LEDs creates a display that is visible through the control panel 22′ of the preamplifier housing. Light from an LED is directed through a decal 26′ on the interior of the control panel 22′ by a light pipe 28′. The material used in the construction of the control panel 22′ is such that the illuminated stencil is visible through the display surface only when illuminated. In one embodiment, the color of the decal corresponds to the color of the control panel or display surface to assist in making the stencil visible through the display surface only when the decal is illuminated.

As discussed above, a tuning circuit is used to activate the LEDs or other light sources that illuminate the tuner display. The tuning circuit can be any conventional tuning circuit that is configured to illuminate the appropriate light sources to generate a display. Although the example illustrated in FIGS. 2-4 is a preamplifier including a light display driven by a tuning circuit, Light displays in accordance with embodiments of the invention can be driven by other circuits within a preamplifier and can be utilized with devices other than preamplifiers that are mounted to musical instruments.

Use of light displays in accordance with embodiments of the invention can remove the need for a decal on the exterior surface of a device that incorporates the light display. The absence of a decal means that a variety of surface treatments can be performed with respect to the surface of the device that incorporates the light display. For example, the surface can be curved in more than one axis and can have texture. The ability to apply multiple surface treatments and to incorporate a light display that is substantially invisible for all practical purposes when not illuminated enables the construction of devices that are less obtrusive, e.g., blends in or appears part of the instrument, when mounted to musical instruments. In one embodiment, the surface treatment is applied to the plastic as part of the molding process, e.g., a texture is burned into the mold surface. The texture is equivalent to 100 grit sandpaper, but in one embodiment textures are between 50 and 200 grit. In one embodiment, the underlying surface of the plastic where the light pipe sandwiches the stencil is flat and with no texture. However, the surface above this is sculpted with multiple axes.

A process for assembling a device including a light display in accordance with an embodiment of the invention is shown in FIG. 5. The process 55 includes constructing (56) the device housing. The housing can be constructed so that multiple surface treatments are applied to the panel that incorporates the light display and so that the interior surface of the panel that incorporates the light display includes a recess and connectors for mounting the light pipe assembly. Following the completion of the housing, the decal is positioned (58) within the recess. In many embodiments, the decal and the recess have the same irregular shape to facilitate alignment. The light pipe assembly is then mounted (60) to the connectors. The mounting of the light pipe presses the decal against the interior surface of the device housing. The circuit board containing LEDs for selective illumination of the decal is installed (62) within the housing and the device is finished (64). In many embodiments, information can be printed on the exterior of the device using pad printing.

The process shown in FIG. 5 is simply one process for assembling a device incorporating a light display in accordance with the present invention. Once assembled, the device can then be mounted to a musical instrument.

While the above description contains many specific embodiments of the invention, these should not be construed as limitations on the scope of the invention, but rather as an example of one embodiment thereof. For example, the display described above can be used in conjunction with any of a variety of analog and/or digital circuits used in the construction of amplification circuitry where the circuitry generates an optical display. Accordingly, the scope of the invention should be determined not by the embodiments illustrated, but by the appended claims and their equivalents.

What is claimed is:

1. A device for mounting to a musical instrument, comprising:
a housing including a light display, wherein the light display comprises:
a decal located against an interior surface of the housing;
a light pipe assembly configured to direct light from at least one light source through the decal; and
a circuit configured to selectively activate the at least one light source;
wherein the housing is constructed from a material that is sufficiently transparent that the decal is not visible unless illuminated by the at least one light source.

2. The device of claim 1, wherein the interior surface of the housing includes a recess and the decal is located within the recess in the housing.

3. The device of claim 2, wherein the light pipe assembly presses the decal against the recess in the interior surface of the housing.

4. The device of claim 3, wherein the light pipe assembly is heat staked to the interior surface of the housing.

5. The device of claim 2, wherein the material is a transparent black ABS material.

6. The device of claim 4, wherein the material includes a level of black pigment between 5% to 50%.

7. The device of claim 1 wherein the decal has an irregular shape and the recess has an irregular shape that corresponds to the irregular shape of the decal.

8. The device of claim 2, wherein:
the at least one light source includes at least one LED; and
the circuit comprises:
an input jack;
an amplifier connected to the input jack;
a tuning circuit connected to the amplifier; and
a power supply connected to the amplifier and the tuning circuit.

9. The device of claim 8, wherein the amplifier amplifies and conditions an input signal from the input jack and the tuning circuit receives the amplified and conditioned signal from the amplifier and determines a note and pitch based the received amplified and conditioned signal.

10. The device of claim 9, wherein the tuning circuit selectively couples power from the power supply to at least one LED based on the determined note and pitch.

11. The device of claim 9, wherein the decal is made of Mylar.

12. The device of claim 1 wherein the housing is surface treated to blend with a surface of the musical instrument.

13. The device claim 1 wherein the housing has an outer surface sculpted along multiple axes.

14. A musical display indicator device, comprising:
a housing mounted on a musical instrument and including a light display, wherein the light display comprises:
a light pipe assembly configured to direct light from at least one light source; and
a circuit configured to selectively activate the at least one light source;
wherein the housing is constructed from a material that is sufficiently transparent that indicators are not visible unless illuminated by the at least one light source.

15. The device of claim 14 wherein the housing is removably mounted to the musical instrument.

16. The device of claim 15 further comprising a decal having the indicators, the decal located against an interior surface of the housing and the at least one light source illuminating the decal.

17. The device of claim 14 wherein the housing is surface treated to blend with a surface of the musical instrument.

18. The device of claim 14 wherein the housing has a textured outer surface that corresponds to about 50 to about 200 grit sandpaper.

19. The device of claim 14, wherein:
the at least one light source includes at least one LED; and
the circuit comprises:
an input jack;
an amplifier connected to the input jack;
a tuning circuit connected to the amplifier; and
a power supply connected to the amplifier and the tuning circuit.

20. A method of constructing a device including a light display, comprising:
constructing a housing that incorporates a control panel including multiple surface treatments, where an interior surface of the control panel includes a recess and connectors;
positioning a decal within the recess in the interior surface of the control panel;
mounting a light pipe assembly to the connectors on the interior surface of the control panel; and
installing a circuit including at least one light source within the housing.

21. The method of claim 20 wherein the housing is made of a transparent material sufficiently transparent that the decal is not visible unless illuminated by the light pipe assembly.

22. The method of claim 20 wherein the transparent material includes a level of black pigment between 5% to 50%.

23. The method of claim 20 wherein:
the at least one light source includes at least one LED; and
the circuit comprises:
an input jack;
an amplifier connected to the input jack;
a tuning circuit connected to the amplifier; and
a power supply connected to the amplifier and the tuning circuit.

24. The method of claim 20 further comprising burning a texture into an outer surface of the housing and sculpting the outer surface of the housing along multiple axes.

25. The method of claim 24 wherein the texture corresponds to about 50 to about 200 grit sandpaper.
